(19) United States
(12) Patent Application Publication
(10) Pub. No.: US 2009/0130916 A1
(43) Pub. Date: May 21, 2009

(54) CONNECTOR AND METHOD FOR INSPECTING CONNECTION PORTIONS OF THE SAME

(76) Inventors: Shinya Ishizuka, Tokyo (JP); Hirokazu Takahashi, Tokyo (JP); Yoshinori Yabe, Tokyo (JP)

Correspondence Address: DICKSTEIN SHAPIRO LLP, 1825 EYE STREET NW, Washington, DC, 20006-5403, US

(21) Appl. No.: 12/265,376

(22) Filed: Nov. 5, 2008

(30) Foreign Application Priority Data
Nov. 20, 2007 (JP) 2007-300,243

(51) Int. Cl. H01R 13/514

(52) U.S. Cl. 439/701

(57) ABSTRACT

A connector to be mounted on a substrate includes a plurality of contacts each having a contact portion adapted to contact a mating object and a connection portion of a surface mounting type to be connected to a substrate, and a housing having inserting holes for arranging and holding the contacts therein and a fitting portion to be fitted with the mating object. The connection portions are arranged substantially in parallel with the bottom surface of the housing. The bottom surface of the housing is provided with protrusions respectively for the contacts for positioning the connection portions in directions of their heights and confirming positions of the connection portions in the longitudinal direction by bringing the individual connection portions into contact with the protrusions, respectively. The connector thus constructed is free from failed electrical connection and easily and visually confirmed whether the contacts are situated in correct positions without using jigs or the like. The invention also provides a method for inspecting the positions of the contacts.

### BACKGROUND OF THE INVENTION

This invention relates to a connector for use with electric and electronic appliances such as portable music players and the like, and a method for inspecting connection portions of the connector, and more particularly to a connector with a structure which makes it possible to position the connection portions in directions of their heights and to visually confirm whether the connection portions are in correct positions in the longitudinal direction.

A hitherto used connector will be explained. The connector comprises at least a plurality of contacts each having a contact portion adapted to contact a mating object and a connection portion to be connected to a substrate, and a housing for arranging and holding the contacts. The connection portions of the contacts are of a surface mounting type (a so-called SMT) and arranged substantially in parallel with the bottom surface of the housing.

As examples of such a connector, incorporated herein are Japanese Utility Model Application Opened No. H07-008,984 (1995) (Patent Literature 1) and Japanese Patent Application Opened No. H09-199,215 (1997) (Patent Literature 2), one of which is the proposal by the applicant of the present case.

Patent Literature 1

According to the abstract of the Japanese Utility Model Application Opened No. H07-008,984 (Patent Literature 1), this Utility Model has an object to provide a connector overcoming a problem of defective electrical connection and short circuit due to deformation of contact tails 20 during treatment (transportation or soldering) of surface mounting type connectors of the prior art. Disclosed is a connector 10 of a surface mounting type including contacts 16 each having at one end a contact tail 20 having a springiness adapted to contact a connection terminal face of a circuit pattern 26 of a printed circuit board 22 and at the other end a contact portion to contact a mating connector, and a housing 14 fixing the contacts 14 and having a fitting portion 12 to be fitted with other connector, wherein between the contact tails 20 of the contacts 16 there are provided partition walls 18 which extend on the order of 0.1 to 0.2 mm from tips of the contact tails 20 and retract upwardly on the order of 0.2 mm from the surfaces of the contact tails 20 adapted to contact the patterns 26 of the printed circuit board 22.

Claim 1 of the Japanese Utility Model Application Opened No. H07-008,984 recites a connector of a surface mounting type including a plurality of contacts each having a contact tail having a springiness adapted to contact a connection terminal face of a circuit pattern of a printed circuit board, and a housing fixing said contacts and having a fitting portion to be fitted with other connector, characterized in that partition walls are provided between the contact tails of said contacts.

Patent Literature 2

According to the abstract of the Japanese Patent Application Opened No. H09-199,215 (Patent Literature 2), this invention has an object to provide a connector so constructed that even if a terminal is inserted at a wrong position in an insulator, its failure can be readily found to improve the productivity of the connector. Disclosed is a connector comprising first terminals each having at one end a contact, a fixed portion contiguous to the contact and to be fixed to an insulator, and an external connection terminal contiguous to the fixed portion and linearly extending, second terminals each having at one end a contact, a fixed portion contiguous to the contact and to be fixed to the insulator, and an external connection terminal contiguous to the fixed portion and formed at an offset bent tip, and the insulator formed with holes for fixing said first and second terminals in the holes with their fixed portions, said insulator comprising protrusions having a height enabling offset bent regions to abut against said protrusions before the second terminals have been fixed to the insulator, said protrusions being located in offset bent directional positions of the second terminals positioned in the same row in the proximities of openings of the holes on the side inserting the first terminals.

Claim 1 of the Japanese Patent Application Opened No. H09-199,215 recites a connector comprising first terminals each having at one end a contact adapted to be connected to a mating connector, a fixed portion contiguous to the contact and to be fixed to an insulator, and an external connection terminal contiguous to the fixed portion and linearly extending from said fixed portion, second terminals each having at one end a contact adapted to be connected to the mating connector, a fixed portion contiguous to the contact and to be fixed to the insulator, and an external connection terminal contiguous to the fixed portion and bent in an offset state, and the insulator formed with holes arranged in aligned with one another and enabling said first and second terminals to be fixed in said holes with their fixed portions when said first and second terminals are inserted with their contacts into said holes, and said insulator comprising protrusions having a height enabling offset bent regions to abut against said protrusions before said second terminals have been fixed to the insulator, said protrusions being located in offset bent directional positions of said second terminals positioned at least in the same row in the proximities of openings of the holes on the side inserting said first terminals. Claim 2 recites the connector claimed in claim 1, wherein the holes of said insulator are formed to be arranged in matrices in two rows, and in the same row said first and second terminals are alternately fixed to the insulator.

With a connector of a surface mounting type whose connection portions are arranged substantially in parallel with the bottom surface of an insulator, generally, there are gaps between the connection portions and the insulator as in the Patent Literature 1. Such gaps make it difficult to position the contacts in directions of their heights, and it is difficult to confirm normal or correct positions of the contacts in the longitudinal direction of the connector. These problems remain to be solved.

The protrusions in the Patent Literature 2 are erroneous insertion-preventing protrusions 14d for preventing the contacts of one kind from being erroneously inserted. In more detail, when a contact of one kind (bent contact) of two kinds (straight contact and bent contact) has been inserted into the hole to a certain extent (before being completely press-fitted), the bent portion of the contact (bent contact) comes into contact with the protrusion, thereby confirming an erroneous insertion. The protrusions in the Patent Literature 2 are limited to the use of two kinds of contacts, and these protrusions do not serve to position contacts and do not function to confirm positions of contacts.

In connectors of the surface mounting type, contacts are generally attached to a substrate by reflow soldering. If there are irregularities in positions of contacts in directions of their heights or the contacts are not in correct positions in the longitudinal direction of the connector, there would be possible locations at which soldering is not achieved and defective soldering, if any, would tend to short-circuit adjacent contacts, and would cause failed electrical connection. Individually confirming positions of the respective contacts will be tedious and time-consuming to increase a manufacturing cost of the connector.

### SUMMARY OF THE INVENTION

In view of the problems of the prior art described above, the invention has been completed, and the invention has an object to provide a connector which makes it possible to visually and easily confirm whether contacts are in correct positions without using jigs or the like, thereby completely preventing defective or failed electrical connection, and a method for inspecting the connector.

The object of the invention can be achieved by the connector 10 to be mounted on a substrate 80, including a plurality of contacts 14 each having a contact portion 24 adapted to contact a mating object 60 and a connection portion 28 of a surface mounting type to be connected to said substrate 80, and a housing 12 having inserting holes 22 for arranging and holding said contacts 14 therein and a fitting portion 20 to be fitted with said mating object 60, constructed according to the invention in that said connection portions 28 of the contacts 14 are arranged substantially in parallel with the bottom surface 34 of said housing 12, and said bottom surface 34 of the housing 12 is provided with protrusions 30 respectively for said contacts 14 for positioning said connection portions 28 in directions of their heights and confirming positions of said connection portions 28 in the longitudinal direction by bringing the connection portions 28 into contact with said protrusions 30, respectively.

The object of the invention can also be achieved by the method for inspecting connection portions 28 of a connector 10 to be mounted on a substrate 80, said connector including a plurality of contacts 14 each having a contact portion 24 adapted to contact a mating object 60 and a connection portion 28 of a surface mounting type to be connected to said substrate 80, and a housing 12 having inserting holes 22 for arranging and holding said contacts 14 therein and a fitting portion 20 to be fitted with said mating object 60, according to the invention comprising steps of arranging said connection portions 28 substantially in parallel with the bottom surface 34 of said housing 12, providing protrusions 30 on said bottom surface 34 of the housing respectively for said contacts 14 for positioning said connection portions 28 in directions of their heights and confirming positions of said connection portions 28 in the longitudinal direction and bringing said connection portions 28 of the contacts 14 into contact with said protrusions 30, respectively, thereby positioning said connection portions 28 in the directions of their heights and confirming the positions of said connection portions 28 in the longitudinal direction.

As can be seen from the above descriptions, the invention can bring about the following significant functions and effects.

(1) A connector claimed in claim 1 is the connector 10 to be mounted on a substrate 80, including a plurality of contacts 14 each having a contact portion 24 adapted to contact a mating object 60 and a connection portion 28 of a surface mounting type to be connected to said substrate 80, and a housing 12 having inserting holes 22 for arranging and holding said contacts 14 therein and a fitting portion 20 to be fitted with said mating object 60, wherein said connection portions 28 of the contacts 14 are arranged substantially in parallel with the bottom surface 34 of said housing 12, and said bottom surface 34 of the housing 12 is provided with protrusions 30 respectively for said contacts 14 for positioning said connection portions 28 in directions of their heights and confirming positions of said connection portions 28 in the longitudinal direction by bringing the connection portions 28 into contact with said protrusions 30, respectively. Therefore, positioning of contacts 14 can be effected by merely inserting the respective contacts 14 into the inserting holes 22 to cause these contacts 14 to be in contact with the protrusions 30, respectively, and the positions of the contacts 14 can be visually confirmed by merely looking at the contacts 14 located within widths of the protrusions 30. Accordingly, the visual inspection can be carried out in a simple manner, and any defective electrical connection can be completely prevented without increase in manufacturing cost.

(2) A method as claimed in claim 2 is the method for inspecting connection portions 28 of a connector 10 to be mounted on a substrate 80, said connector including a plurality of contacts 14 each having a contact portion 24 adapted to contact a mating object 60 and a connection portion 28 of a surface mounting type to be connected to said substrate 80, and a housing 12 having inserting holes 22 for arranging and holding said contacts 14 therein and a fitting portion 20 to be fitted with said mating object 60, according to the invention comprising steps of arranging said connection portions 28 substantially in parallel with the bottom surface 34 of said housing 12, providing protrusions 30 on said bottom surface 34 of the housing respectively for said contacts 14 for positioning said connection portions 28 in directions of their heights and conforming positions of said connection portions 28 in the longitudinal direction, and bringing said connection portions 28 of the contacts 14 into contact with said protrusions 30, respectively, thereby positioning said connection portions 28 in the directions of their heights and confirming the positions of said connection portions 28 in the longitudinal direction. Consequently, positioning of contacts 14 can be effected by merely inserting the respective contacts 14 into the inserting holes 22 to cause these contacts 14 to be in contact with the protrusions 30, respectively, and the positions of the contacts 14 can be visually confirmed by merely looking at the contacts 14 located within widths of the protrusions 30. Accordingly, the visual inspection can be carried out in a simple manner, and any defective electrical connection can be completely prevented without increase in manufacturing cost.

The invention will be more fully understood by referring to the following detailed specification and claims taken in connection with the appended drawings.

### BRIEF DESCRIPTION OF THE DRAWINGS

FIG. 1A is a perspective view of a connector according to the invention, viewed from its fitting opening to show the side to be connected to a substrate;

FIG. 1B is a perspective view of a connector according to the invention, viewed from the side opposite from the fitting opening to show the side to be connected to the substrate;

FIG. 2A is a perspective view of a housing, viewed from its fitting opening to show the side to be connected to the substrate;

FIG. 2B is a perspective view of a housing, viewed from the side opposite from the fitting opening to show the side to be connected to the substrate;

FIG. 3A is a perspective view of a contact;

FIG. 3B is a perspective view of a first switch terminal;

FIG. 3C is a perspective view of a second switch terminal;

FIG. 4A is a cross-sectional view of the connector according to the invention mounted on a substrate, taken along a protrusion;

FIG. 4B is a longitudinal-sectional view of the connector mounted on the substrate, taken along a protrusion; and

FIG. 4C is a sectional view of the connector mounted on the substrate with a mating object inserted, taken along the center of the mating object.

### DESCRIPTION OF THE PREFERRED EMBODIMENTS

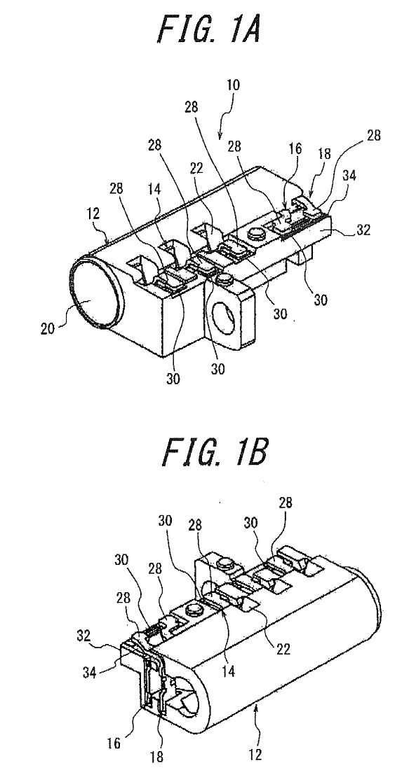

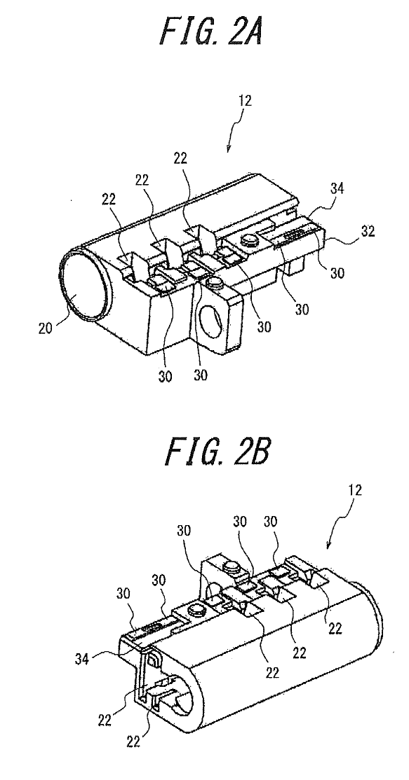

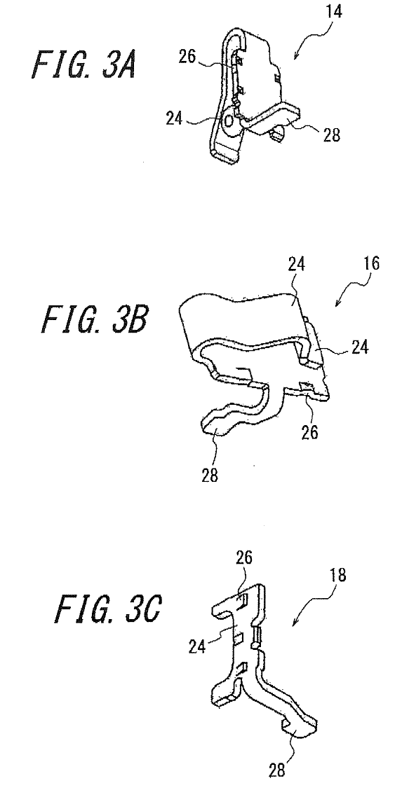

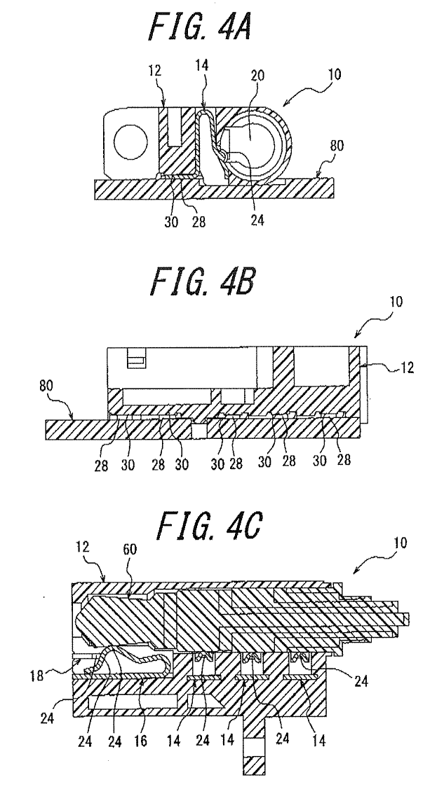

The connector and the inspecting method of connection portions according to the invention will be explained with reference to FIGS. 1A to 4C. FIG. 1A is a perspective view of the connector according to the invention, viewed from its fitting opening to show the side to be connected to a substrate, and FIG. 1B is a perspective view of the connector, viewed from the side opposite from the fitting opening to show the side to be connected to the substrate. FIG. 2A is a perspective view of a housing, viewed from its fitting opening to show the side to be connected to the substrate, while FIG. 2B is a perspective view of the housing, viewed from the side opposite from the fitting opening to show the side to be connected to the substrate. FIG. 3A is a perspective view of a contact, and FIG. 3B is a perspective view of a first switch terminal, while FIG. 3c is a perspective view of a second switch terminal. FIG. 4A is a sectional view of the connector according to the invention mounted on the substrate, taken along a protrusion, while FIG. 4B is a longitudinal sectional view of the connector mounted on the substrate, taken along a protrusion, and FIG. 4C is a sectional view of the connector with a mating object inserted, taken along the center of the mating object.

The connector 10 according to the invention comprises at least a plurality of the contacts 14, and the housing 12 and in the illustrated embodiment further comprises the first switch terminal 16 and the second switch terminal 18.

Before explaining the components of the connector according to the invention, a plug connector (jack) 60 which is a mating object will be explained. The plug connector 60 is substantially bar-shaped as shown in FIG. 4C and is provided with contacts at locations corresponding to the plurality of contacts 14. The contacts of the plug connector 60 are adapted to contact the contacts 14 to exchange signals.

Forming very important aspects of the invention are a connector which is free from defective or failed electrical connection and has a structure by which an operator can readily and visually ascertain whether the contacts are situated in normal or correct positions without using any jigs or the like, and a method for inspecting the connector. In more detail, in a surface mounting type (SMT) connector where connection portions 28 of the contacts 14 are arranged substantially parallel to the bottom surface of the housing 12, protrusions 30 are provided to make it possible to position the connection portions 28 in their vertical directions and to confirm the positions of the connection portions 28 in the longitudinal direction by bringing the connection portions 28 into contact with the protrusions 30, thereby enabling the positions of the connection portions 28 of the contacts 14 to be visually confirmed.

First, the housing 12 will be explained which is a subject matter of the invention, with reference to FIGS. 2A and 2B. The housing 12 is formed from an electrically insulating plastic material by means of the injection molding of the known technique. The materials for the housing 12 may be suitably selected in consideration of dimensional stability, heat resistance, workability, manufacturing cost, and the like, and generally include polybutylene terephthalate (PDT), polyamide (66PA or 46PA), liquid crystal polymer (LCP), polycarbonate (PC), polyphenylene sulfide (PPS), and the like and combined materials thereof. The housing 12 has a substantially U-shaped cross-section.

Said housing is formed with a fitting portion (fitting opening) 20 for inserting said plug connector 60 therein. The size and shape of said fitting portion 20 may be suitably designed in consideration of the shape and size of said plug connector 60 and the connectivity of the plug connector 60 with the contacts 14. Said housing 12 is further formed with inserting holes 22 for inserting and holding the contacts 14 and the first switch terminal 16 and the second switch terminal 18. The inserting holes 22 for said contacts 14 are provided at locations corresponding to those of the contacts of said plug connector 60 so as to enable electrical connection between contact portions 24 of the contacts 14 and the contacts of the plug connector 60.

Since the first and second switch terminals 16 and 18 serve to judge whether the plug connector 60 has been inserted into the connector 10, the inserting holes 22 for the first and second switch terminals 16 and 18 are located on the side of the housing 12 opposite from the fitting portion or fitting opening 20 and on the same side as those of the contacts 14 so that the first switch terminal 16 is able to contact said plug connector 60, while the first and second switch terminals 16 and 18 are able to contact each other. The shapes and sizes of the inserting holes 22 may be suitably designed taking into account the shapes and sizes of the contacts 14 and the first and second switch terminals 16 and 18, and holding force, miniaturization, workability, strength, and the like.

On the bottom 34 of the housing 12, on which a substrate 80 is to be mounted, there are provided protrusions 30 at locations corresponding to the connection portions 28 of said contacts 14 and said first and second switch terminals 16 and 18. The protrusions 30 not only serve to position said contacts 14 and said first and second switch terminals 16 and 18 in directions of their heights but also serve to ascertain the positions of said contacts 14 and said first and second switch terminals 16 and 18 in the longitudinal directions of the connector 10 when they have been press-fitted (inserted) into the housing 12. In more detail, the respective connection portions 28 of said contacts 14 and said first and second switch terminals 16 and 18 are brought into contact with said protrusions 30, respectively, to effect the positioning of the contacts 14 and the terminals 16 and 18 in the directions of their heights, while the positions of the connection portions 28 of said contacts 14 and said first and second switch terminals 16 and 18 in the longitudinal direction of the connector are confirmed depending on whether the connection portions 28 are positioned within widths of said protrusions 30, respectively.

Sizes of said protrusions 30 may be suitably designed in consideration of the functions described above, the sizes and positional accuracies (tolerances) and the like of the connection portions 28 of said contacts 14 and said first and second switch terminals 16 and 18. In the embodiment, the protrusions 30 are on the order of 0.05 to 0.2 mm larger than the connection portions, respectively. Heights of said protrusions 30 may be suitably designed taking into account heights of the press-fitted (inserted) contacts 14 and first and second switch terminals 16 and 18.

The contacts 14 will then be explained. The contacts 14 are made of a metal and formed by mean of the press-working of the known technique. Preferred metals from which to form said contacts 14 include brass, beryllium copper, phosphor bronze and the like which comply with the requirements as to dimensional stability, electric conductivity, and the like. The contacts 14 are substantially in the form of a U-shape as shown in FIG. 3A, and each comprise mainly a contact portion 24 adapted to contact said plug jack 60, a fixed portion 26 to be held in said housing 12, and a connection portion 28 to be connected to the substrate 80. Said contact portion 24 is adapted to contact a mating object such as a contact of a mating connector. The shape and the size of the contact portions 24 may be suitably designed in consideration of contact stability and contact pressure with a mating object, workability, and the like. In the illustrated embodiment, the contact portion 24 is of a raised or convex shape. Said fixed portion 26 is held in the housing 12, and press-fitted into said housing 12 in the embodiment. Said connection portions 28 are of a surface mounting type (SMT) where the connection portions 28 are arranged in parallel with the bottom surface of said housing 12, and are connected to the substrate 80 by soldering such as reflow soldering.

Finally, the first switch terminal 16 and the second switch terminal 18 will be explained. The first and second switch terminals 16 and 18 are arranged in the side of the housing opposite from the fitting opening for inserting the mating object or plug connector 60 so as to be able to judge whether the mating object or plug or jack connector 60 has been inserted into the connector 10. In other words, with this construction, whether said jack connector 60 has been inserted or not can be judged depending on the first and second switch terminals 16 and 18 are in contact with each other (ON state), or out of contact with each other (OFF state). In the embodiment, when said jack connector 60 is inserted into the connector 10, the first and second switch terminals 16 and 18 become out of contact (OFF state), thereby confirming the insertion of the jack connector 60.

Said first and second switch terminals 16 and 18 are made of a metal and formed by means of the press-working of the known technique. Preferred metals from which to form said first and second switch terminals 16 and 18 include brass, beryllium copper, phosphor bronze and the like which comply with the requirements as to dimensional stability, electric conductivity, and the like. Said first and second switch terminals 16 and 18 each comprise a contact portion 24 adapted to contact the mating switch terminal 18 or 16, a fixed portion 26 to be fixed in said housing 12, and a connection portion 28 to be connected to said substrate 80.

Now, the method for inspecting the connection portions 28 of the connector 10 will be explained.

The first inspection is to visually confirm whether the connection portions 28 of said contacts 14 and said first and second switch terminals 16 and 28 are in contact with the protrusions 30 of said housing, respectively.

The second inspection is to visually confirm whether the connection portions 28 of said contacts 14 and the first and second switch terminals 16 and 18 are located within the widths of the protrusions 30 of said housing 12, respectively. The second inspection is performed simultaneously with the first inspection.

Since the first and second inspections are visually performed, the positions of the connection portions 28 of said contacts 14 and the first and second switch terminals 16 and 18 can be simply confirmed.

Needless to say, the present invention is not to be limited to the connector 10 as shown in the illustrated embodiment. The invention is applicable to all connectors of surface mounting types (SMT) in which connection portions of contacts are arranged in parallel with the bottom surface of a housing. Moreover, it is to be understood that the invention is also applicable to switch terminals and the like other than the contacts, insofar as connection portions are surface mounting types (SMT).

Examples of applications of the invention are electrical connectors for use with electric or electronic appliances such as portable music players, and more particularly connectors with a structure making it possible to position connection portions in directions of their heights and to visually confirm whether the connection portions are in correct positions in the longitudinal direction.

While the invention has been particularly shown and described with reference to the preferred embodiments thereof, it will be understood by those skilled in the art that the foregoing and other changes in form and details can be made therein without departing from the spirit and scope of the invention.

What is claimed is:

1. A connector to be mounted on a substrate, including a plurality of contacts each having a contact portion adapted to contact a mating object and a connection portion of a surface mounting type to be connected to said substrate, and a housing having inserting holes for arranging and holding said contacts therein and a fitting portion to be fitted with said mating object,
wherein said connection portions of the contacts are arranged substantially in parallel with the bottom surface of said housing, and
said bottom surface of the housing is provided with protrusions respectively for each of said contacts for positioning said connection portions of the contacts of their heights by contacting therewith and confirming positions of said connection portions in the longitudinal direction.

2. A method for inspecting connection portions of a connector to be mounted on a substrate, said connector including a plurality of contacts each having a contact portion adapted to contact with a mating object and a connection portion of a surface mounting type to be connected to said substrate, and a housing having inserting holes for arranging and holding said contacts therein and a fitting portion to be fitted with said mating object, comprising steps of:
arranging said connection portions substantially in parallel with the bottom surface of said housing,
providing protrusions on said bottom surface of the housing respectively for each of said contacts for positioning said connection portions of the contacts of their heights by contacting therewith and confirming positions of said connection portions in the longitudinal direction, and
bringing said connection portions of the contacts into contact with said protrusions, respectively, thereby positioning said connection portions in their heights and confirming the positions of said connection portions in the longitudinal direction.
